(19) United States
(12) Patent Application Publication
(10) Pub. No.: US 2010/0161424 A1
(43) Pub. Date: Jun. 24, 2010

(54) TARGETED ADVERTISING SYSTEM AND METHOD

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 12/341,335

(22) Filed: Dec. 22, 2008

(51) Int. Cl. G06Q 30/00; G06F 7/06; G06F 17/30

(52) U.S. Cl. 705/14.66; 707/E17.143

(57) ABSTRACT

As an advertisement is presented to the user via a user terminal, the user terminal may generate voting information in response to a specific user input that bears on the user's interest in the advertisement or based on actions or behaviors of the user in association with the advertisement being presented. When specific user input is provided, the user is essentially providing direct feedback as to whether the advertisement is of interest. The voting information is provided to the targeted advertising system, which will update the preference information based on the voting information such that the user's interest in the various advertisements is reflected in the preference information. As new advertisements are selected for the user, the selection of the advertisements is based on the updated preference information, which is systematically updated as voting information is received from the one or more user terminals.

### FIELD OF THE DISCLOSURE

The present invention relates to targeted advertising, and in particular to controlling targeted advertising based on voting information associated with the presentation of advertisements.

### BACKGROUND

Most media content providers, such as television, radio, magazine, newspaper, and internet providers are heavily, if not completely, dependent on advertising revenue. The revenue generated from advertising is generally linked to how well and to what extent advertisements are presented to a desired audience. Further, the success of a product or service is often based on being able to effectively market the product or service to the desired audience. As such, the ability for a content provider to deliver advertising to the desired audience is critical for both the content provider as well as the provider of the product or service.

While the need to deliver advertising in an effective manner remains critical, the ability to effectively deliver advertising has been eroding with the advent of digital video recorders (DVRs), satellite radio, and the Internet. DVRs allow viewers to record television content that includes advertisements and skip over the advertisements when subsequently viewing the recorded television content. Satellite radio is becoming more popular and many of the most popular stations are commercial free. The Internet poses numerous issues ranging from virtually eliminating the commercial viability of print media to making available so much content that it is difficult for advertisers to determine where they should advertise. Further, with the proliferation of these different types of content mediums, advertisers are generally forced to choose some content mediums over others or provide fewer advertisements over a greater number of content mediums, wherein doing so may leave out a large contingent of the desired audience.

Given the importance and expense of advertising and the increasing difficulty in reaching the desired audience, extensive efforts have been made to provide advertising that is targeted to specific individuals and deliverable to these individuals in a more effective manner. Such personalized advertising generally involves obtaining information about a user's behavior or the media content that is viewed by the user and identifying advertisements to present to the user based on the information. However, the information obtained about the user is still relatively general, and it is often difficult to ascertain the most effective advertisements for a given user and how to deliver the advertisements based on such generalized information. Personal information may also be obtained for or provided by the user and used to identify advertisements to present to the user. If the personal information is general, selecting effective advertisements remains relatively difficult.

Certain targeted advertising schemes are being developed where the user provides personal information that identifies preferences for advertisements of a particular type, style, with particular content, and the like. As the specificity of the personal information increases, the effectiveness of selecting advertisements of interest for the user increases. For example, a user may provide personal information that indicates they are interested in cooking, travel, and automobiles, and based on the personal information, cooking, travel, and automobile related advertising is selected for delivery and presentation to the user. Notably, user interests change over time. While a user may be interested in automobiles when in the market for a new car, once a new car is purchased, their interest in automobile related advertising may wane while an interest in furniture evolves. If the user does not update their personal information to identify their new interest in furniture, ineffective advertising ensues.

Personalized advertising systems generally maintain a profile for a given user or household associated with a user. The profile is used to store the general or specific profile information that is obtained from the user or about the user from any number of sources. The profile information is then used to select advertisements to present to the user. Unfortunately, users are not likely to update the profile information in their profiles because of complacency or the inconvenience or difficulty associated with updating the profile. As their preferences change from the last time the profile information was updated, the effectiveness of the advertising that is selected for the user based on the profile information decreases. As such, there is a need for an efficient and effective technique for keeping the profile information for a user pertinent and up-to-date.

Further, personalized advertising systems are generally dedicated to a particular content medium, such that television content providers maintain a separate personalized advertising system from that of a radio or Internet content provider. Each personalized advertising system for the different content mediums will maintain a separate profile, if a profile is maintained at all, with different profile information. The different profiles will be used exclusively for the associated content medium, and no common profile for the user is made available across content mediums for targeting advertisements to the user via the different content mediums. Accordingly, there is a further need for an efficient and effective technique to maintain a single, up-to-date profile across different content mediums and use the profile to present targeted advertisements to the user via the different content mediums.

### SUMMARY OF THE DETAILED DESCRIPTION

The present invention relates to a targeted advertising system that is capable of selecting advertisements for delivery to a user in a targeted manner. The advertisements are selected based on preference information that is maintained in a profile for the user. The preference information bears on the interests that the user may have in receiving advertisements of a certain type or style or pertaining to certain content. As an advertisement is presented to the user via a user terminal, the user terminal may generate voting information in response to a specific user input that bears on the user's interest in the advertisement or based on actions or behaviors of the user in association with the advertisement being presented. When specific user input is provided, the user is essentially providing direct feedback as to whether the advertisement is of interest, and in certain configurations an indication of how much interest the user has in the advertisement. The voting information is provided to the targeted advertising system, which will update the preference information based on the voting information such that the user's interest in the various advertisements is reflected in the preference information. As new advertisements are selected for the user, the selection of the advertisements is based on the updated preference information, which is systematically updated as voting information is received from the one or more user terminals.

In different embodiments, the targeted advertising system may, but need not, serve any number of user terminals, which are supported by the same of different communication mediums. Further, the advertisements and any media content, such as television programs, web content, and the like, may be of different media types, which are directed to the same or different user terminals over the same or different communication mediums. As such, the targeted advertising system may be configured to provide a single profile for different user terminals that are served by different communication mediums. Advertisements to be presented to the user via the different user terminals may be selected in light of common preference information in the single profile. As advertisements are presented by the user terminals and corresponding voting information is received from the user terminals, the common preference information is updated to represent the overall and evolving preferences of the user. The targeted advertising system may instruct an advertising source to deliver the selected advertisements to one or more user terminals of the user, send information that identifies the selected advertisements to the user terminals, or actually provide the selected advertisements to the user terminals in a desired manner.

Those skilled in the art will appreciate the scope of the present invention and realize additional aspects thereof after reading the following detailed description in association with the accompanying drawings.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is a block representation of a communication environment.

FIGS. 2A and 2C are exemplary preference profiles.

FIGS. 2B, 2D, and 2E illustrate exemplary voting information and associated metadata.

FIGS. 3A and 3B provide an exemplary communication flow for a particular targeted advertising process.

FIG. 4 is a block representation of a targeted advertising server.

FIG. 5 is a block representation of a user terminal.

FIG. 6 is a block representation of a computer premise equipment based user terminal.

### DETAILED DESCRIPTION

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

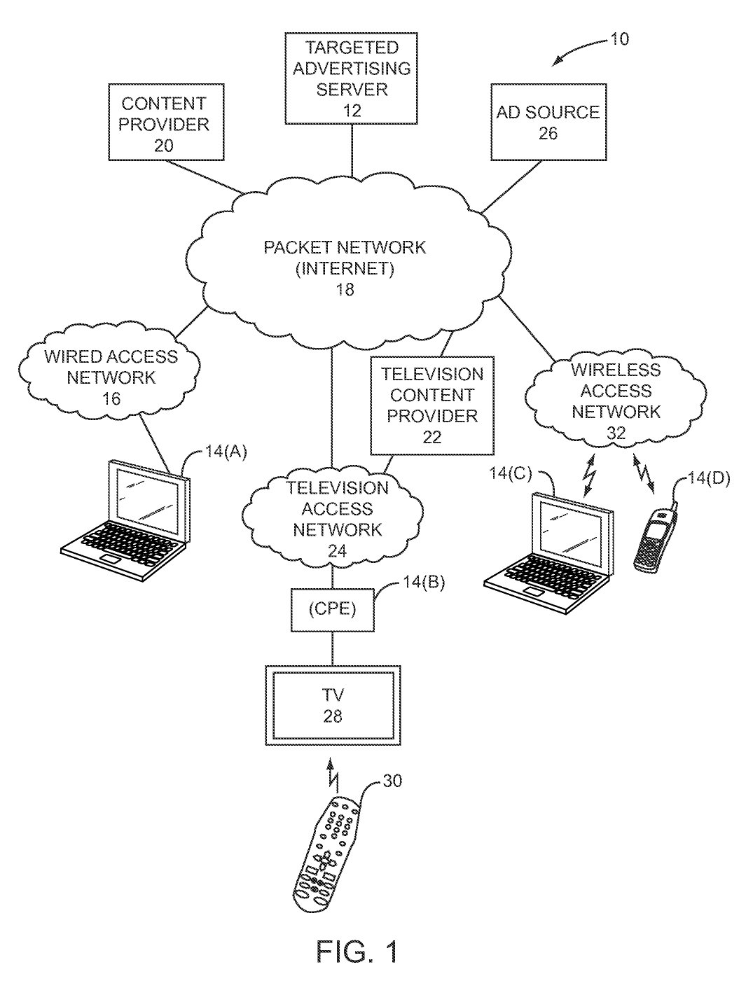

With reference to FIG. 1, a communication environment 10 is provided where a targeted advertising server 12 is capable of interacting with one or more user terminals 14 through one or more communication mediums to facilitate targeted advertising. Notably, the user terminals are generally referenced as 14, and when referenced individually, referenced as 14(A) through 14(D). In particular, the targeted advertising server 12 maintains user preferences for a given user or limited group of users, such as a household at a particular residence. The user preferences provide information that is used by the targeted advertising server 12 to select from a large group of advertisements those advertisements that are deemed to be of interest or otherwise desirable to the particular user. The user preferences are generally provided in a profile that is associated with the user, wherein the profile may include various other information that is sufficient to identify the user, user terminals 14 that are associated with the user, and the like.

At some time, the user profile is established for the user and initial preference information for the user is established by default or based on information provided by a service provider, advertiser, the user, or any combination thereof. Based on the preference information, the targeted advertising server 12 will systematically select advertisements to be presented to the user in association with the presentation of other media content, such as television content, web content, or the like. Information that identifies the advertisements and how to present the advertisements in association with general or specific media content is either provided to the user terminal 14 or a provider of the media content. If the information is delivered to the user terminal 14, the user terminal 14 will obtain the identified advertisements in advance or when needed and present the advertisements in association with the media content to the user as instructed by the targeted advertising server 12. If the information is delivered to the provider of the media content, the provider will obtain the identified advertisements, insert or otherwise associate the advertisements with the media content to be delivered to the user as instructed by the targeted advertising server 12, and deliver the media content along with the advertisements to the user via an appropriate user terminal 14. The user terminal 14 will then present the media content and the associated advertisements to the user as instructed.

This process of selecting advertisements that are deemed of interest or otherwise desirable to the user may be provided relatively continuously or systematically in an iterative fashion. With the present invention, the user terminals 14 are configured to allow the users to directly or indirectly provide feedback that is indicative of their relative interests in or the desirability of a particular advertisement. The feedback may be provided as or in close proximity to the time the advertisement is presented to the user. This feedback that is provided by users for advertisements is referred to as voting information, wherein users are effectively allowed to vote on advertisements. The relative complexity or granularity of the voting information that is provided by a user for a given advertisement may vary with implementation. For example, the user terminal 14 may simply allow the user to vote for those advertisements of interest, wherein votes are not provided for those advertisements that are not of interest to the user. In other configurations, the user is able to indicate whether the advertisement is either of interest or not of interest in a binary fashion or effectively rate a given advertisement along a defined or sliding scale.

While the voting information may be based on direct user feedback, the user terminal 14 may predict the user's relative interest in an advertisement based on the user's actions or behavior with regard to being presented an advertisement or the media content. For example, the user terminal 14 may generate voting information for a given advertisement on behalf of the user when the user does not provide direct feedback for the advertisement. If the user does not provide feedback for the advertisement, the user terminal 14 may consider such lack of feedback as a lack of interest in the advertisement, average interest in the advertisement, indifference to the advertisement, or the like. If the user terminal 14 determines that the user viewed an advertisement while playing back a previously recorded program, the user terminal 14 may consider the viewing of advertisements that could have been skipped as an indication of interest in the advertisement and generate corresponding voting information. If the user terminal 14 determines that the user skipped over or through an advertisement while playing back a previously recorded program, the user terminal 14 may consider such action as an indication of lack of interest in the advertisement and generate corresponding voting information. If the user terminal 14 determines that the user viewed a given advertisement multiple times while watching live programming or playing back a previously recorded program, the user terminal 14 may consider such action as an indication of interest in the advertisement and generate corresponding voting information. The voting information derived from the user's actions or behavior may be applied to a binary or scaled rating system, as described above.

The voting information that was obtained through direct user feedback or derived based on user actions or behavior for the advertisements for which votes were collected are provided to the targeted advertising server 12 in batches or upon being determined. The targeted advertising server 12 will process the voting information and update the user preferences based on the voting information. Since the voting information is indicative of the type, style, or content of advertisements that are of interest to the user, the targeted advertising server 12 can process the voting information and determine how the preference information can be modified or changed to better reflect the current interests of the user. The targeted advertising server 12 will use the updated preference information to select advertisements for the user and the cycle will repeat. As the cycle of providing advertisements that are selected based on the user preferences, receiving new voting information of the user, and updating the preference information of the user continues, the targeted advertising server 12 is able to effectively and efficiently maintain preference information that accurately represents and continuously tracks the changing the preferences of the user.

Since the voting information for an advertisement may generally pertain to an overall advertisement, the particular aspect of the advertisement that makes the advertisement interesting to the user may not be clear when considered in isolation. However, as numerous advertisements with both similar and different characteristics are voted on, the targeted advertising server 12 will be able to analyze information that bears on the type, style, or content of the advertisements in light of the voting information associated with the advertisements and generate new preference information or update existing preference information to reflect new or changing interests of the user.

As illustrated in FIG. 1, the user terminals 14 may take various forms, provide different primary functionalities, and be supported by different communication mediums. For example, user terminal 14(A) is supported via a wired access network 16, which is coupled directly or indirectly to a packet network 18, such as the Internet. The wired access network 16 may represent a local or metropolitan area network or the like. User terminal 14(A) may represent a personal computer, personal digital assistant, telephone terminal, or the like that is capable of receiving one more type of media content, such as internet web pages, streaming audio or video, television programming and the like from an appropriate content provider 20. The media content may include advertisements. Alternatively, the media content may include locations or slots in which advertisements may be inserted by the content provider 20 or by the user terminal 14(A). The user terminal 14(A) may be controlled by an appropriate keyboard, mouse, or the like, which may also be used by the user to provide voting and other related input.

User terminal 14(B) may take the form of a set-top box, digital video recorder (DVR), receiver, or like customer premise equipment (CPE), which is capable of receiving television content from a television content provider 22 over a television access network 24, such as a cable access network or the like, and presenting select television content to the user. The television content is considered a subset of media content and will generally include programming content for defined programs in defined channels or made available on demand. The television content may include advertisements or slots in which advertisements may be inserted by the television content provider 22 or by the CPE 14(B). If inserted by the CPE 14(B), the CPE 14(B) will download and store advertisements for insertion, and then insert select advertisements in the television content in the defined slots prior to the television content being presented to the user. Advertisements may be obtained or downloaded from an advertisement (ad) source 26 by the CPE 14(B) or television content provider 22. As depicted, the CPE 14(B) may be associated with or integrated into a television 28 or like monitor on which the television content and advertisements may be presented. The CPE 14(B) and television 28 may be controlled by a remote control 30, which may also be used by the user to provide voting and other related input. Further, the television access network 24 may provide access to the packet network 18, such that the CPE 14(B) can access internet content, such as web pages and streaming audio and video.

User terminals 14(C) and 14(D) are depicted as being supported via a wireless access network 32, which is coupled directly or indirectly to the packet network 18. The wireless access network 32 may represent a cellular, wireless local area network (WLAN), or the like. User terminal 14(C) may represent a personal computer, personal digital assistant while user terminal 14(D) represents a mobile telephone terminal or the like that is capable of receiving one or more types of media content from an appropriate content provider 20 and perhaps advertisements from the ad source 26. Although a different communication medium is used, the user terminals 14(C) and 14(D) may operate in the same or analogous fashion as user terminal 14(A). Through the different communication mediums, the user terminals 14(A-D) are able to communicate with the targeted advertising server 12, provide voting related information, and in certain configurations, receive information that identifies the advertisements to present to the user.

As indicated, user preferences are embodied in preference information, which is used by the targeted advertising server 12 to select the advertisements to send to the user via an appropriate user terminal 14. The type and configuration of preference information may take many forms and will vary from one implementation to another. As an example, different advertisements may be assigned to one or more advertising classes (ad classes) to which they relate. Each ad class effectively defines a group, set, or kind of advertisement based on the type, style, content, or the like of the advertisement. The preference information that is maintained in a profile for a given user may identify a select group of available ad classes from a number of available ad classes. Placing an ad class in the preference profile may indicate an interest (or disinterest) of some level in advertisements that belong to the ad class. To further refine the preference information, some or all of the classes may be associated with a variable weighting factor. The relative interest in advertisements associated with different ad classes in the preference profile may be changed to reflect changing interests of the user by changing the respective weighting factors. Further ad classes may be added or removed from the preference profile to reflect the changing interests of the user. The addition of ad classes to the preference profile may be used to help identify new preferences or relative interest in these ad classes.

Each advertisement may have metadata that is provided with or tied in some fashion to the advertisement. The metadata for an advertisement and the advertisement itself may be linked through an advertisement identifier (ad ID), wherein the metadata is stored with the advertisement identifier and the advertisement includes or is presented in association with the advertisement identifier. As advertisements are presented to the user, the user terminals 14 will generate voting indicium that bears on the user's interest in the advertisement as a whole. The voting indicium for an advertisement may be associated with the advertisement identifier for the advertisement to generate the voting information for that advertisement. The voting information for each advertisement may be provided along with or in a group to the targeted advertising server 12. The advertisement identifier may take numerous forms, such as a URL, a text string, a number, or any combination thereof, and can be associated or embedded in the advertisement media, such as being inserted in the vertical blanking intervals for television media. In some embodiments, the advertisement identifier may be obtained indirectly. For example, the advertising identifier may be derived by determining when an advertisement was presented to the user and the media (e.g. television channel) through which the advertisement was provided, and subsequently retrieving from a media source, such as the television content provider 22, the actual advertisement identifier associated with that time, media, and user.

Based on the advertising identifier that is provided in or with the voting information for the advertisement, metadata for the advertisement may be obtained by the targeted advertising server 12. The metadata for the advertisement may identify or provide information sufficient to determine any ad classes to which the advertisement relates. The ad classes of the advertisement are compared to the ad classes in the preference profile to identify any ad classes of the advertisement that appear in the preference profile. For each ad class in the preference profile that is represented in the metadata of the advertisement, the targeted advertising server 12 will apply the voting indicium for the corresponding advertisement. Thus, the relative interest of the user in the overall advertisement, as reflected in the voting indicium for the advertisement, is applied to weighting factors for ad classes that are in the preference profile and relate to the advertisement. For example, if the advertisement is associated with one or more ad classes that are in the preference profile and the voting indicium indicates that the user liked, disliked, or was neutral about the advertisement, the weighting factors for the ad classes that are in the preference profile and associated with the advertisement are updated accordingly.

Exemplary metadata for an advertisement for a 2008 Honda Civic is provided in the table below. For purposes of illustration, each category of metadata may correspond to an ad class that relates to the advertisement. The preference profile may include none, one, or more of these ad classes, and in certain embodiments, associate weighting factors with the different classes based on user preferences.

TABLE 1
Ad Classes for 2008 Honda Civic Advertisement

<category>cars
<brand>Honda
<model>Civic
<year>2008
<type>sport
<price.range>15,000-25,000
<target.reach>national
<target.age>20-30
<target.sex>male
<ads.type>humor
<ads.duration>60 seconds
<ads.location>Canada
<ads.uniqueID>54586364646634

As indicated above, the metadata for the advertisement for the 2008 Honda Civic may be broken into multiple ad classes. As illustrated, there are three types of ad classes: ad classes related to the content of the advertisement, ad classes that relate to the targeted demographic for the advertisement, and add classes related to characteristics of the advertisement itself. For instance, the category (cars), brand (Honda), model (Civic), year (2008), and type (sport) relate to the content of the advertisement, and in particular the product being advertised. The target.reach (national), target.age (20-30), and target.sex (male) ad classes correspond to the target demographic. The ads.type (humor), ads.duration (60 seconds), ads.location (Canada), and ads.uniqueID (54586364646634) relate to a theme of the advertisement, the length of the advertisement, a location associated with the advertisement, and an advertising identifier (ad ID) associated with the advertisement. The metadata does not need to remain with the advertisements, and may be provided at a separate location, such as the ad source 26, which is accessible by the targeted advertising server 12. Regardless of whether the metadata is maintained with the advertisements as they are provided alone or with program content to the various user terminals 14, it is preferable that the user terminals 14 be able to identify any advertisements that are being presented to a user and being voted on by the user.

Further, not all of the metadata needs to correspond to an ad class, and multiple portions or types of metadata may be used in conjunction to identify a given ad class. For example, the metadata for the advertisement indicates that the targeted demographic is males between the ages of 20 and 30. As such, the ad may be mapped by the targeted advertising server 12 to an ad class for young adults in general or young males that generally covers an age range of 18-35 when a corresponding age group or gender-based ad class is not available. Although specific types of preference information and ad classes are described herein, the preference information, including a particular ad class or select group of ad classes, may relate to any one or combination of the following with any desired degree of specificity:
advertising type (audio, video, image, graphic, or the like);
advertising medium (cable, Internet, cellular, wireless, or the like);
general or specific types of products or services, particular companies or brands, types of companies or brands;
price or price range of product or service;
a certain advertising style (humorous, romantic, informative) or advertising theme (holiday, adult, children, sports, business, leisure, or the like);
a defined demographic (age, income, gender, religion, nationality, and the like), location, or time period of applicability (expiration date); and
a specific or relative length (time in seconds), size, resolution, or the like.

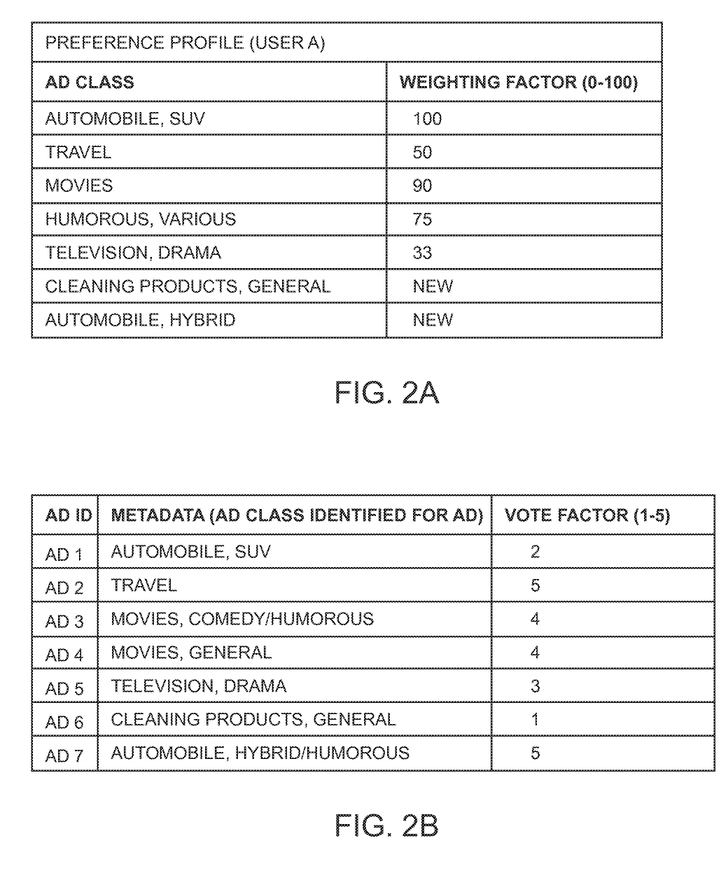

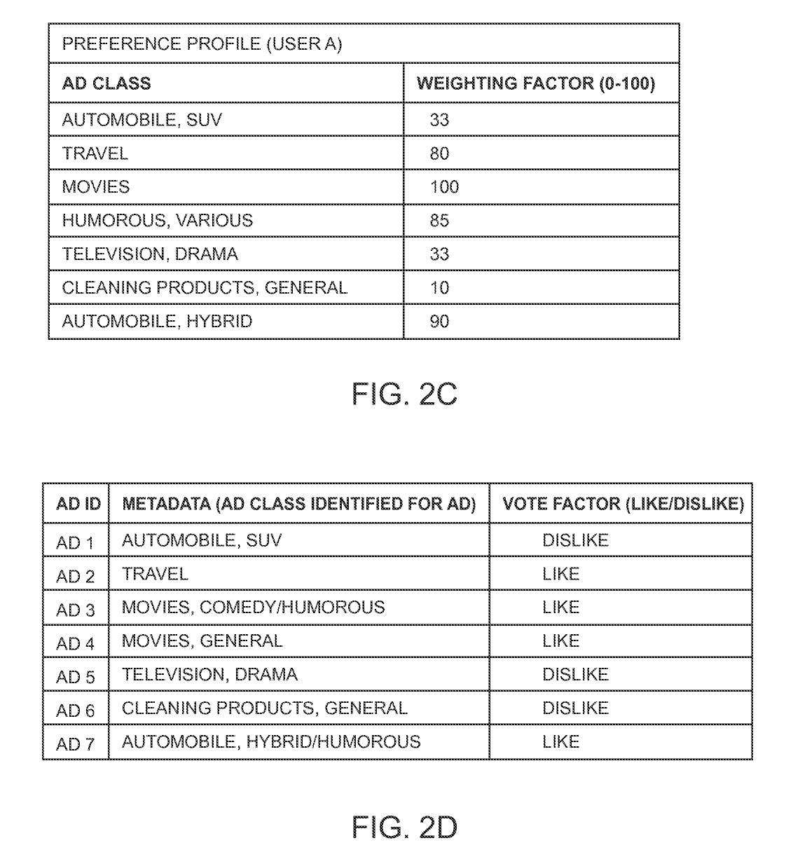

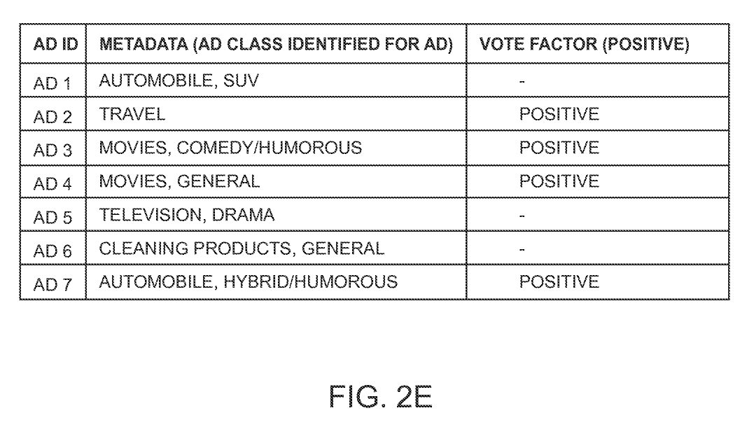

An exemplary preference profile for a user, User A, is provided in FIG. 2A, wherein the preference information includes information bearing on ad classes and associated weighting factors. Notably, the weighting factors may range from 0-100, wherein a higher weighting factor corresponds to a higher probability that User A will be interested in an ad that is associated with a corresponding ad class. The ad classes that are in the preference profile relate to SUV type automobiles, travel, movies, humorous advertisements for various products and having various themes, television dramas, cleaning products in general, and hybrid type automobiles. The weighting factors corresponding to these ad classes reflect a probability that User A is interested in advertisements that are classified within a corresponding ad class. For example, SUV type automobiles has a weighting factor of 100, which indicates that the user is very likely to be interested in advertisements that relate to SUVs. The other weighting factors indicate that the user is likely to be very interested in advertisements pertaining to movies and advertisements that have humorous themes, regardless of the product or service being advertised. The weighting factors also indicate that the user is less likely to be interested in advertisements related to travel and television dramas. Two of the ad classes do not have specific weighting factors, and are indicated as being new. These ad classes have yet to be provided a weighting factor, and perhaps may correspond to ad classes that are associated with new types or styles of advertisements or advertisements with content that has yet to be presented to the user, voted on by the user, or the like. As advertisements are presented to the user that relate to these unweighted ad classes, the voting information for these advertisements may be used to generate an actual weighting factor for the corresponding ad classes. Notably, the preference profile illustrated in FIG. 2A may represent only a portion of the preference information that is maintained for User A.

Based on the preference information in the preference profile for User A, the targeted advertisement server 12 will instruct the user terminal 14, content provider 20, television content provider 22, or any combination thereof to provide advertisements to the user. As dictated by the weighting factors, the targeted advertising server 12 will preferably effect the delivery of more SUV related advertising than television drama related advertising. In an effort to obtain information bearing on whether User A is interested in cleaning products or hybrid automobiles, advertisements for cleaning products and hybrid automobiles may also be provided to User A.

As the advertisements are presented to User A, either User A is provided an opportunity to vote on the particular advertisements as they are being presented, or the user terminal 14 is monitoring User A's actions or behavior to determine User A's relative interest in the advertisements. Based on User A's input, actions, behavior, or a combination thereof, the user terminal 14 will generate voting information that is associated with each of the advertisements and provide the voting information over the respective communication medium to the targeted advertising server 12.

As indicated above, the voting information may take various forms and have varying degrees of granularity. In this example, assume that the user or user terminal 14 either provides or generates voting information that provides a vote factor between one and five for each of the advertisements that is associated with voting information. With reference to FIG. 2B, assume that seven different advertisements were presented to User A and received voting information. The advertisements are identified using an ad ID (AD 1 through AD 7). The voting factor for each ad is provided along with at least one ad class with which the advertisement is associated. The ad class may be ascertained based on metadata that is associated with the advertisements, but is not needed to be provided with the advertisements. As such, the targeted advertising server 12 may access the ad source 26 using the ad IDs to obtain the metadata for the advertisements. Based on the metadata, the targeted advertising server 12 may identify the ad classes to which the advertisement relates. Based on the vote factors that were provided for a given advertisement, and thus are associated with each of the ad classes to which the advertisement relates, the targeted advertising server 12 will update the weighting factors associated with any affected ad classes in the preference profile of User A.

Further, the targeted advertising server 12 may provide new weighting factors for ad classes that previously did not have a weighting factor. Exemplary new and updated weighting factors for the example provided in association with FIG. 2A and 2B are provided in the updated preference profile of FIG. 2C. Assume one of the advertisements that was provided to User A and voted on by User A was an advertisement relating to SUVs (AD 1). Further assume that the vote factor for the advertisement (AD 1) was a two, which is an indication that the user was not interested in the advertisement in general. The targeted advertising server 12 may determine that User A is no longer interested in SUV related advertisements, because the advertisement AD 1 was associated with the ad class for SUVs. Accordingly, the targeted advertising server 12 may reduce the weighting factor for the ad class associated with SUVs from 100 to 33, as illustrated in FIG. 2C. Continuing with the example, assume the vote factors for advertisements AD 3 and AD 4 were fours, which indicates a relatively high interest in the overall advertisements by User A. These advertisements were related to movies, and in particular advertisement AD 3 was related to a comedy, while advertisement AD 4 was related to movies in general. The targeted advertising server 12 may apply the general showing of interest by User A for these movie related advertisements, and increase the weighting factor associated with the ad class for movies in the preference profile for User A, as illustrated in FIG. 2C. In particular, the weighting factor for the ad class for movies is increased from 90 to 100, given the continued showing of interest for advertisements relating to movies. For the ad classes that were previously unweighted, the low vote factor of one for the advertisement AD 6 translates into a low weighting factor for the ad class related to general cleaning products, while the high vote factor of five for advertisement AD 7 translates into a high weighting factor of 90 for the ad class related to hybrid automobiles. Notably, the voting information may also result in ad classes being removed from the preference profile when the voting information indicates that there is little or no interest in advertisements related to the ad class.

The vote factors illustrated in FIG. 2B indicate that User A has the opportunity to not only vote on advertisements that are being presented, but also to provide a relative ranking on a continuous or graduated scale. As indicated above, various input mechanisms may be employed to receive voting information of various types. While the vote factors provided in FIG. 2B may range along a scale of one to five, FIGS. 2D and 2E illustrate alternative voting information forms. In FIG. 2D, the user is not able to provide voting information along a graduated scale, but is able to indicate whether they like or dislike a particular advertisement in an affirmative manner. With reference to FIG. 2E, the user is either able to provide input indicating that they like (as shown) or dislike a particular advertisement. Not voting on an advertisement is indicative of neutrality, interest, or lack of interest, depending on the configuration. In addition to providing direct input from the users, similar voting information may be derived by the user terminal 14 based on the user's behavior or actions associated with being presented the advertisements themselves, the media content that is provided along with the advertisements, or a combination thereof. In any of the above configurations, not voting on a particular advertisement may be simply ignored or considered a passive input, which will result in actual or implied voting information. Voting information may be provided by the user through the remote control 30, dedicated buttons, soft keys, keyboards, touch screens, mice, or the like.

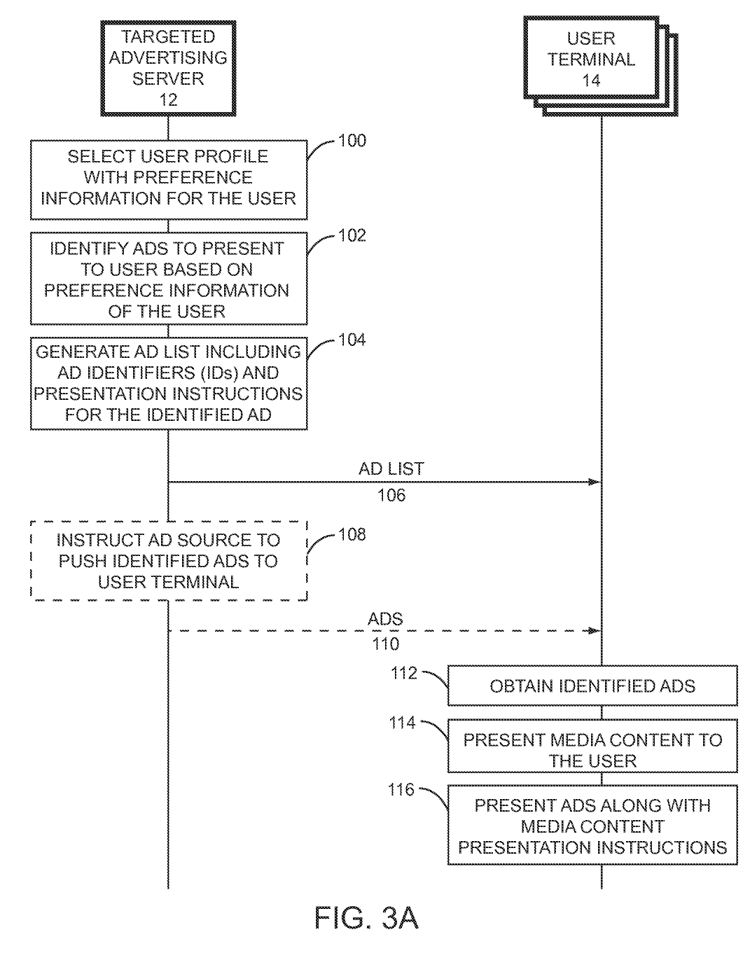

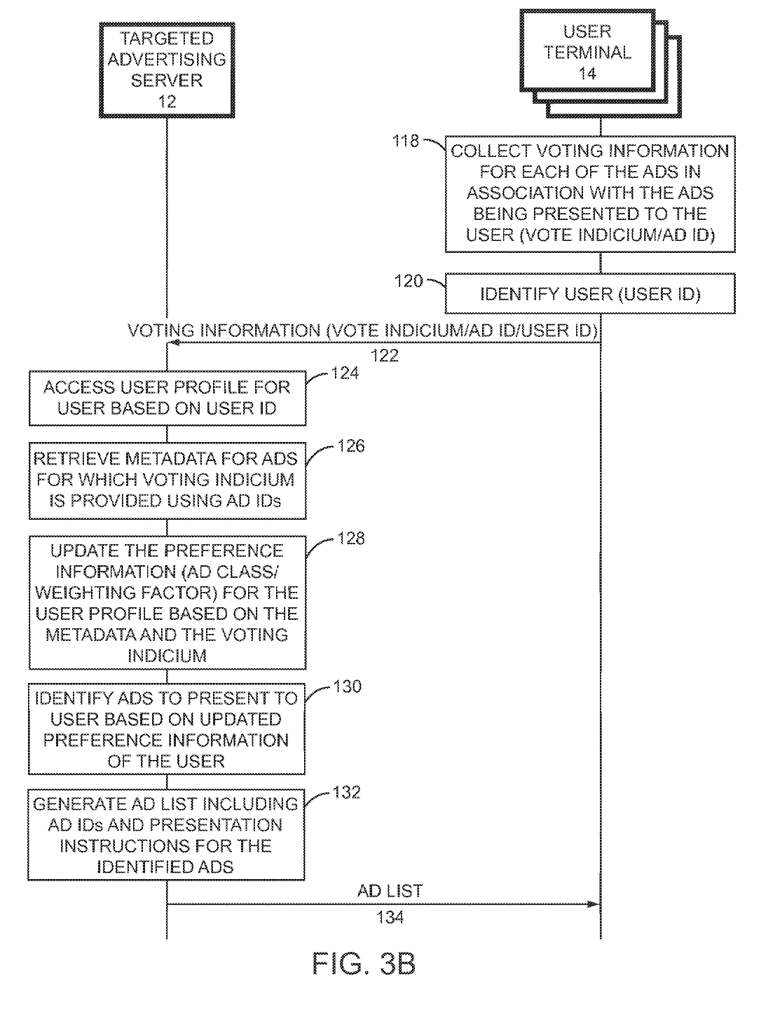

With reference to FIGS. 3A and 3B, a communication flow is provided to illustrate an example of how preference information for a user may be updated based on voting information that is provided from a user or in association with a user's actions or behavior. With the following example, it is assumed that the targeted advertising server 12 has information sufficient to identify a particular user or household associated with the user. A user may have one or more profiles, which may be provide for a particular communication medium, user terminal 14, time, or the like. Notably, the user may have a single profile that supports user terminals 14, where communications are supported through different types of communication mediums. For example, a single profile may be used for targeting advertising for advertisements provided to a user's CPE (user terminal 14(B)), as well as the user's mobile terminal (user terminal 14(D)). A single profile may be able to handle advertisements provided in different media forms, such as internet web pages or video-based content. For the following example, assume that a single profile is being used to support different user terminals 14, which are supported by different communication mediums. Further, the advertisements may be provided in different types of media. Although interaction with only one user terminal 14 is illustrated, these interactions may be replicated with multiple user terminals 14 at any given time or throughout a given period of time. The voting information retrieved from the various user terminals 14 may be implemented as appropriate to effect the preference information, such that voting provided via the CPE 14(B) may affect advertising provided to the mobile terminal 14(D), the CPE 14(B), or a combination thereof. The targeted advertising server 12 may take into consideration the capabilities of the user terminals 14 when determining what advertisements, and the form of advertisements, to provide to the respective user terminals 14.

The targeted advertising server 12 will normally have to identify the user or the user terminal 14 that is associated with the user in order to select the appropriate profile to use for selecting advertisements and modifying preference information based on any available voting information. Identification of the user or the user terminal 14 may be provided by the user or the user terminal 14 in a manual or automated fashion. For CPEs 14(B), such as set-top boxes, DVRs, televisions, and the like, the CPE 14(B) may allow a user to select from one or more profiles, wherein different users within the household may have their own profiles. The user may provide input to select the profile or identify themselves in some fashion using an appropriate interface or the remote control 30. If a particular profile or a particular user is not selected, the CPE 14(B) may default to a designated profile or user. The CPE 14(B) may upload any user identification or user terminal identification information to the targeted advertising server 12 for selecting a profile that will be used for selecting advertisements and processing voting information. Alternatively, the targeted advertising server 12 may identify any voting information from the CPE 14(B) as being associated with a particular user and select the profile based on identifying information of the CPE 14(B).

For internet-based services, identification of the user or the associated user terminal 14 may be provided through a login procedure for the targeted advertising server 12, or may be provided to the targeted advertising server 12 from internet content servers. As such, the provider of the media content may be able to identify the user and provide the identification for the user to the targeted advertising server 12. For other user terminals 14, communication addresses, directory numbers, and the like may be used to identify the user or the associated user terminal 14. In one configuration, the user terminal 14 that is providing voting information will provide user or user terminal identification information along with the voting information, such that the targeted advertising server 12 will be able to associate the voting information with a particular user profile.

Continuing with FIGS. 3A and 3B, the process begins when the targeted advertising server 12 selects a user profile that contains preference information for the user (step 100). The targeted advertising server 12 will identify advertisements to present to the user based on preference information of the user (step 102) and then generate an ad list that includes ad identifiers (ad IDs) and presentation instructions (step 104). The ad list may not include the advertisements themselves, but may merely include identifiers for advertisements that should be delivered to the user via one or more of the user terminals 14. Since the preference information is used, the advertisements identified in the ad list are likely to be of interest to the user. The ad list may be provided to the user terminal 14 (step 106) or to another entity, such as the ad source 26, which will provide the advertisement content for the advertisements identified in the ad list to the appropriate user terminals 14 in advance or as needed (steps 108 and 110). Alternatively, the targeted advertising server 12 may maintain the advertising content for the advertisements identified in the ad list and provide the advertisements to the user terminal 14 in advance or as needed. As yet another option, the targeted advertising server 12 may provide the ad list to the television content provider 22, which will access the advertising content for the advertisements and provide the advertisements along with program content. Accordingly, the advertising content may be provided as part of or integrated into the program content that is provided to the user terminal 14 from the television content provider 22 or content provider 20. If the advertising content is not provided with the primary media content that is being provided to the user terminal 14, the user terminal 14 may fetch the advertising content in advance or as needed, as described below (step 112).

From the perspective of the user terminal 14, advertisements may be presented to the user in different ways. If the advertisements are integrated with the media content that is provided by the content provider 20 or television content provider 22, the user terminal 14 may identify the advertisements that are present in the media content. If the advertisements are not integrated within the media content, the user terminal 14 may receive the ad list provided by the targeted advertising server 12 and obtain the ads identified in the ad list upon receiving the ad list or in a dynamic fashion as the advertisements are needed. The advertising content for the advertisements may be separate from the media content, wherein the user terminal 14 is configured to insert the advertising content for the advertisements in the media content at the appropriate location or at the appropriate time based on the presentation instructions provided in the ad list. For television content, the presentation instructions may indicate that certain advertisements should be allocated to certain advertising slots within the media content. For internet content, the advertising content may be provided in a certain location of a web page, which represents the primary media content that is being accessed by the user. If the advertising content is provided separately from the media content, the user terminal 14 may present any media content to the user that is being accessed or selected by the user (step 114) and present the advertising content for the ads along with the media content based on the presentation instructions (step 116).

Whether the advertising content is already integrated with the media content or inserted into the media content by the user terminal 14, the user terminal 14 is able to identify at least certain advertisements that are being presented to the user via the user terminal 14, and in association with the advertisements being presented to the user, collect voting information for those advertisements (step 118). As indicated above, the voting information may be provided directly from the user or derived based on the user's actions or behavior associated with the advertisements being presented to the user. The user terminal 14 may provide some audible or visual indication to indicate when voting may take place, and in response, the user may provide voting information through an available input mechanism of the user terminal 14. Notably, there is no need for an audible or visible indication to alert a user that voting is possible. The user terminal 14 may automatically be ready to receive voting information from the user at any time, or when advertisements are being presented. Further, the remote control 30 or other input mechanism for a user terminal 14 may include special “hot” keys or the like that are dedicated to voting, and when these keys are selected, corresponding voting information is recorded by the user terminal 14. The voting information for a given advertisement may include a single input or a sequence or inputs, wherein the information conveyed in response thereto may range from simply indicating a like or dislike for the advertisement, or a relative rating that is provided over a graded or continuous scale.

As an alternative to providing direct input or as a supplement to such input, the user terminal 14 may monitor the user's actions or behavior to generate voting information. Regardless of the source of the voting information, the voting information will generally include vote indicium, which relates to the intent of the vote and an advertising identifier (ad ID) that identifies the advertisement with which the voting indicium is associated. Preferably, the user terminal 14 will automatically associate the advertising identifier with any vote indicium provided by the user or generated by the user terminal 14.

At some point prior to providing the voting information to the targeted advertising server 12, the user terminal 14 may identify the user to which the media content and advertisements are being provided (step 120). The identity of the user (user ID) may be that of the actual user or the user terminal 14, and will be used to aid the targeted advertising server 12 in identifying the particular profile to which the voting information pertains. The voting information is provided to the targeted advertising server 12, perhaps along with the user ID that identifies the user or the user terminal 14 (step 122). Although the voting information is illustrated as being provided to the targeted advertising server 12 with the user identification, the user identification may be provided by the user terminal 14 at any time, and in select embodiments, may be obtained from sources other than the user terminal 14.

Upon receipt of the voting information, which includes the vote indicium for one or more advertisements and advertising identifiers for the advertisements, the targeted advertising server 12 will access the user profile based on the user ID (step 124) and retrieve the metadata for those ads for which voting indicium is provided using the advertising identifiers (ad IDs) (step 126). Based on the metadata and the voting indicium, the targeted advertising server 12 will then update the preference information, such as the associated ad classes and weighting factors, for the user profile (step 128).

The process of effecting the delivery of targeted advertisements to the user via the various user terminals 14 will continue, and as voting information for these advertisements is fed back to the targeted advertising server 12, the preference information is dynamically adjusted based thereon. Further, the targeted advertising server 12 will continue to identify ads to present to the user through one or more of the user terminals 14 based on the systematically updated preference information of the user (step 130) and generate an ad list and presentation instructions for the identified advertisements (step 132). The ad list may be delivered, as appropriate, to one or more of the user terminals 14 (step 134), the content provider 20, the television content provider 22, or the like. In addition to updating preference information based on voting information that is provided from one or more user terminals 14, the user may log into the targeted advertising server 12 from an appropriate user terminal 14 and directly configure preference information based on their interests or desires for targeted advertising.

To encourage users to participate in targeted advertising, and in particular to vote on advertisements that are presented to them through various types of media content, the targeted advertising server 12 may generate credits, which can be exchanged for various benefits to the user. For example, credits may be used to reduce the duration or number of advertisements that are presented to the user in association with the delivery of primary media content, or in exchange for other services, such as obtaining on-demand content. In other configurations, the credits may simply be applied as credits to access or service charges that are normally billed to the user.

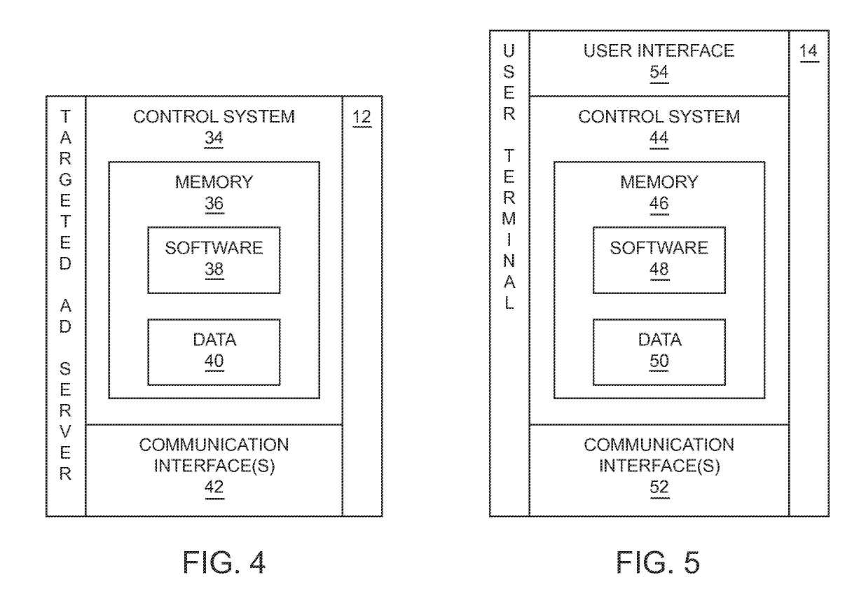

With reference to FIG. 4, a block representation of a targeted advertising server 12 is illustrated to include a control system 34 having sufficient memory 36 for the requisite software 38 and data 40 to operate as described above. The control system 34 is associated with one or more communication interfaces 42 to facilitate communications with the various entities in the communication environment 10.

With reference to FIG. 5, a basic user terminal 14, such as a mobile telephone 14(D) or personal computer 14(A), is illustrated. The user terminal 14 will include a control system 44 having sufficient memory 46 for the requisite software 48 and data 50 to operate as described above. The control system 44 may also include a communication interface 52 to facilitate communications over an appropriate access medium, as well as a user interface 54 to facilitate receiving input and providing output, such as the media content, from and to a user, respectively. The user interface 54 may include a mouse, keyboard, keypad, display, microphone, speaker, and the like.

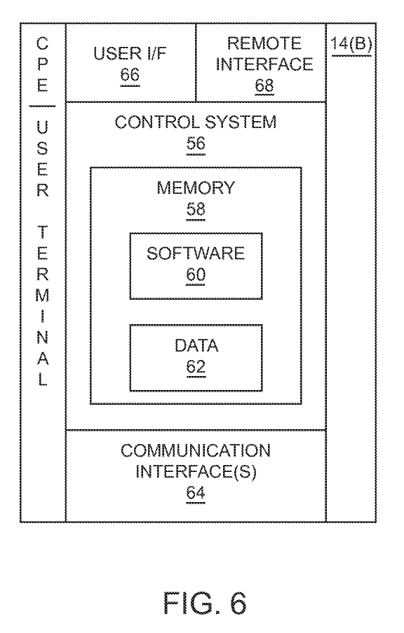

With reference to FIG. 6, a CPE-based user terminal 14(B) is illustrated. The CPE 14(B) may include a control system 56 having sufficient memory 58 for the requisite software 60 and data 62 to operate as described above. The control system 56 may be associated with one or more communication interfaces 64 to facilitate the receipt of advertising and media content from various sources as well as provide voting information to the targeted advertising server 12. The control system 56 may also be associated with a user interface 66 to facilitate receiving input and providing output, such as the media content, from and to a user, respectively. The user interface 66 may include the necessary data, audio, or video interfaces that may be required to connect to audio/video receivers, televisions, monitors, and the like. The control system 56 may also be associated with a keypad, display, and remote interface 68, which will facilitate receiving user input provided via the remote control 30.

Those skilled in the art will recognize improvements and modifications to the embodiments of the present invention. All such improvements and modifications are considered within the scope of the concepts disclosed herein and the claims that follow.

What is claimed is:

1. A targeted advertising server comprising:
at least one communication interface; and
a control system associated with the at least one communication interface and adapted to:
access a preference profile of a user comprising preference information bearing on targeted advertising preferences of the user; and
in an iterative fashion:
select a set of advertisements for delivery to at least one user terminal of the user based on the preference information;
effect delivery of the set of advertisements to the at least one user terminal;
receive from the at least one user terminal voting information indicative of an interest the user had in select advertisements of the set of advertisements when each of the select advertisements was being presented to the user via the at least one user terminal; and
update the preference information of the preference profile in light of the voting information.

2. The targeted advertising server of claim 1 wherein the voting information comprises an advertisement identifier and voting indicium for each of the select advertisements, the voting indicium bearing on the interest the user has in a corresponding advertisement of the select advertisements and the advertisement identifier being sufficient to identify the corresponding advertisement.

3. The targeted advertising server of claim 2 wherein the voting indicium bears on specific user input provided by the user in response to the corresponding advertisement being presented to the user and indicative of the interest the user has in the corresponding advertisement.

4. The targeted advertising server of claim 3 wherein the specific user input is indicative of the user having interest in the corresponding advertisement.

5. The targeted advertising server of claim 3 wherein the specific user input is indicative of the user not having interest in the corresponding advertisement.

6. The targeted advertising server of claim 3 wherein the specific user input is indicative of a relative interest in the corresponding advertisement along a sliding scale.

7. The targeted advertising server of claim 2 wherein the voting indicium bears on an action or behavior of the user at the at least one user terminal in response to the corresponding advertisement being presented to the user and indicative of the interest the user has in the corresponding advertisement.

8. The targeted advertising server of claim 7 wherein the action or behavior is one of a group consisting of skipping over the corresponding advertisement; viewing the corresponding advertisement multiple times; and viewing the corresponding advertisement, when the corresponding advertisement is presented with locally stored television content that was previously stored on the at least one user terminal.

9. The targeted advertising server of claim 1 wherein user identification that identifies the user is provided with the voting information and the preference profile is selected based on the user identification.

10. The targeted advertising server of claim 1 wherein different advertisements of the set of advertisement are delivered to each of a plurality of user terminals and at least a portion of the voting information for the different advertisements is received from corresponding ones of the plurality of user terminals.

11. The targeted advertising server of claim 10 wherein a first of the plurality of user terminals is supported by a first communication medium and the second of the plurality of user terminals is supported by a second communication medium that is different than the first communication medium.

12. The targeted advertising server of claim 10 wherein the different advertisements are presented as different types of media.

13. The targeted advertising server of claim 12 wherein at least one of the different advertisements is a television advertisement and at least another of the different advertisement is a web-based advertisement.

14. The targeted advertising server of claim 1 wherein to effect delivery of the set of advertisements, the control system is further adapted to generate a list of advertisements of the set of advertisements and deliver the list of advertisements to the at least one user terminal, which will obtain advertisements in the list of advertisements from at least one content source.

15. The targeted advertising server of claim 1 wherein to effect delivery of the set of advertisements, the control system is further adapted to generate a list of advertisements of the set of advertisements and deliver the list of advertisements to at least one content source, which will provide the advertisements in the list of advertisements to the at least one user terminal.

16. The targeted advertising server of claim 1 wherein the at least one user terminal is customer premise equipment, which is adapted to provide television content from a television content provider to the user, and wherein advertisements of the set of advertisements are provided to the user in association with the television content.

17. The targeted advertising server of claim 1 wherein the preference information comprises advertising classes for advertisements and weighting factors that are associated with the advertising classes.

18. The targeted advertising server of claim 17 wherein each advertising class defines one or more of a group, set, and kind of advertisement that relates to one or more of a type, style, and content for an advertisement.

19. The targeted advertising server of claim 17 wherein for at least one iteration, to update the preference information, the control system is further adapted to change a weighting factor for at least one of the advertising classes.

20. The targeted advertising server of claim 17 wherein for at least one iteration, to update the preference information, the control system is further adapted to add an advertising class to the advertising classes of the preference profile.

21. The targeted advertising server of claim 17 wherein for at least one iteration, to update the preference information, the control system is further adapted to remove an advertising class from the advertising classes of the preference profile.

22. The targeted advertising server of claim 17 wherein the voting information comprises an advertisement identifier and voting indicium for each of the select advertisements, the voting indicium bearing on the interest the user has in a corresponding one of the select advertisements, the control system further adapted to:
obtain metadata for each of the select advertisements based on the advertising identifier for each of the select advertisements; and
identify ones of the advertising classes that relate to each of the select advertisements based on the metadata for each of the select advertisements,
wherein updating the preference information comprises applying the voting indicium for corresponding ones of the select advertisements to corresponding ones of the advertising classes in the preference information.

23. A method for operating a targeted advertising system comprising:
accessing a preference profile of a user comprising preference information bearing on targeted advertising preferences of the user; and
in an iterative fashion:
selecting a set of advertisements for delivery to at least one user terminal of the user based on the preference information;
effecting delivery of the set of advertisements to the at least one user terminal;
receiving from the at least one user terminal voting information indicative of an interest the user had in select advertisements of the set of advertisements when each of the select advertisements was being presented to the user via the at least one user terminal; and
updating the preference information of the preference profile in light of the voting information.

24. The method of claim 23 wherein the voting information comprises an advertisement identifier and voting indicium for each of the select advertisements, the voting indicium bearing on the interest the user has in a corresponding advertisement of the select advertisements and the advertisement identifier being sufficient to identify the corresponding advertisement.

25. The method of claim 24 wherein the voting indicium bears on an action or behavior of the user at the at least one user terminal in response to the corresponding advertisement being presented to the user and indicative of the interest the user has in the corresponding advertisement.

26. The method of claim 25 wherein the voting indicium bears on specific user input provided by the user in response to the corresponding advertisement being presented to the user and indicative of the interest the user has in the corresponding advertisement.

27. The method of claim 25 wherein the action or behavior is one of a group consisting of skipping over the corresponding advertisement; viewing the corresponding advertisement multiple times; and viewing the corresponding advertisement, when the corresponding advertisement is presented with locally stored television content that was previously stored on the at least one user terminal.

28. The method of claim 23 wherein the preference information comprises advertising classes for advertisements and weighting factors that are associated with the advertising classes.

29. The method of claim 28 wherein the voting information comprises an advertisement identifier and voting indicium for each of the select advertisements, the voting indicium bearing on the interest the user has in a corresponding one of the select advertisements, the method further comprising:
obtaining metadata for each of the select advertisements based on the advertising identifier for each of the select advertisements; and
identifying ones of the advertising classes that relate to each of the select advertisements based on the metadata for each of the select advertisements,
wherein updating the preference information comprises applying the voting indicium for corresponding ones of the select advertisements to corresponding ones of the advertising classes in the preference information.
